(19) United States
(12) Patent Application Publication
(10) Pub. No.: US 2018/0108138 A1
(43) Pub. Date: Apr. 19, 2018

(54) METHOD AND SYSTEM FOR SEMANTIC SEGMENTATION IN LAPAROSCOPIC AND ENDOSCOPIC 2D/2.5D IMAGE DATA

(71) Applicant: Siemens Aktiengesellschaft, Munich (DE)

(72) Inventors: Stefan Kluckner, Berlin (DE); Ali Kamen, Skillman, NJ (US); Terrence Chen, Princeton, NJ (US)

(21) Appl. No.: 15/568,590

(22) PCT Filed: Apr. 29, 2015
(86) PCT No.: PCT/US2015/028120

§ 371 Date: Oct. 23, 2017

(51) Int. Cl. G06T 7/11; G06K 9/32; G06T 7/13; G06T 7/33

(52) U.S. Cl. CPC G06T 7/11; G06K 9/3233; G06T 7/13; G06T 2207/30004; G06T 2207/10028; G06T 2207/10068; G06T 7/344

(57) ABSTRACT

A method and system for semantic segmentation laparoscopic and endoscopic 2D/2.5D image data is disclosed. Statistical image features that integrate a 2D image channel and a 2.5D depth channel of a 2D/2.5 laparoscopic or endoscopic image are extracted for each pixel in the image. Semantic segmentation of the laparoscopic or endoscopic image is then performed using a trained classifier to classify each pixel in the image with respect to a semantic object class of a target organ based on the extracted statistical image features. Segmented image masks resulting from the semantic segmentation of multiple frames of a laparoscopic or endoscopic image sequence can be used to guide organ specific 3D stitching of the frames to generate a 3D model of the target organ.

### BACKGROUND OF THE INVENTION

The present invention relates to semantic segmentation of anatomical objects in laparoscopic or endoscopic image data, and more particularly, to segmenting a 3D model of a target anatomical object from 2D/2.5D laparoscopic or endoscopic image data.

During minimally invasive surgical procedures, sequences of images are laparoscopic or endoscopic images acquired to guide the surgical procedures. Multiple 2D images can be acquired and stitched together to generate a 3D model of an observed organ of interest. However, due to complexity of camera and organ movements, accurate 3D stitching is challenging since such 3D stitching requires robust estimation of correspondences between consecutive frames of the sequence of laparoscopic or endoscopic images.

### BRIEF SUMMARY OF THE INVENTION

The present invention provides a method and system for semantic segmentation in intra-operative images, such as laparoscopic or endoscopic images. Embodiments of the present invention provide semantic segmentation of individual frames of an intra-operative image sequence which enables understanding of complex movements of anatomical structures within the captured image sequence. Such semantic segmentation provides structure specific information that can be used in to improve the accuracy 3D model of a target anatomical structure generated by stitching together frames of the intra-operative image sequence. Embodiments of the present invention utilize various low-level features of channels provided by laparoscopy or endoscopy devices, such as 2D appearance and 2.5 depth information, to perform the semantic segmentation.

In one embodiment of the present invention, an intra-operative image including a 2D image channel and a 2.5D depth channel is received. Statistical features are extracted from the 2D image channel and the 2.5D depth channel for each of a plurality of pixels in the intra-operative image. Each of the plurality of pixels in the intra-operative image is classified with respect to a semantic object class of a target organ based on the statistical features extracted for each of the plurality of pixels using a trained classifier.

In another embodiment of the present invention, a plurality of frames of an intra-operative image sequence are received, wherein each frame is a 2D/2.5D image including a 2D image channel and a 2D depth channel. Semantic segmentation is performed on each frame of the intra-operative image sequence to classify each of a plurality of pixels in each frame with respect to a semantic object class of the target organ. A 3D model of the target anatomical object is generated by stitching individual frames of the plurality of frames together using correspondences between pixels classified in the semantic object class of the target organ in the individual frames.

These and other advantages of the invention will be apparent to those of ordinary skill in the art by reference to the following detailed description and the accompanying drawings.

### BRIEF DESCRIPTION OF THE DRAWINGS

FIG. 1 illustrates a method for generating an intra-operative 3D model of a target anatomical object from 2D/2.5D intra-operative images, according to an embodiment of the present invention;

FIG. 2 illustrates a method of performing semantic segmentation of a 2D/2.5D intra-operative image according to an embodiment of the present invention;

FIG. 3 illustrates an exemplary scan of the liver and corresponding 2D/2.5D frames resulting from the scan of the liver;

FIG. 4 illustrates exemplary laparoscopic images of the liver;

FIG. 5 illustrates exemplary results of semantic segmentation of a laparoscopic image of the liver; and

FIG. 6 is a high-level block diagram of a computer capable of implementing the present invention.

### DETAILED DESCRIPTION

The present invention relates to a method and system for semantic segmentation in laparoscopic and endoscopic image data and 3D object stitching based on the semantic segmentation. Embodiments of the present invention are described herein to give a visual understanding of the methods for semantic segmentation and 3D object stitching. A digital image is often composed of digital representations of one or more objects (or shapes). The digital representation of an object is often described herein in terms of identifying and manipulating the objects. Such manipulations are virtual manipulations accomplished in the memory or other circuitry/hardware of a computer system. Accordingly, is to be understood that embodiments of the present invention may be performed within a computer system using data stored within the computer system.

According to an embodiment of the present invention, as sequence of 2D laparoscopic or endoscopic images enriched with 2.5D image date (depth date) are taken as input, and a probability for a semantic class is output for each pixel in the image domain. This segmented semantic information can then be used to improve the stitching of the 2D image data into a 3D model of one or more target anatomical objects. Due to segmentation of relevant image regions in the 2D laparoscopic or endoscopic images, the stitching procedure can be improved by adapting to specific organs and their movement characteristics. Embodiments of the present invention utilize a training phase, which uses a supervised machine learning concept to train a classifier based on labeled training data, and a testing phase in which the trained classifier is applied to newly input laparoscopic or endoscopic images to perform the semantic segmentation. For both training and testing, a set of extracted features can be learned and classified using efficient random decision tree classifiers or any other machine learning technique. These powerful classifiers are inherently multi-class and can provide real-time capabilities for the testing phase during a surgical procedure. Embodiments of the present invention can be applied to 2D intra-operative images, such as laparoscopic or endoscopic images, having corresponding 2.5D depth information associated with each image. Is to be understood that the terms “laparoscopic image” and “endoscopic image” are used interchangeably herein and the term “intra-operative image” refers to any medical image data acquired during a surgical procedure or intervention, including laparoscopic images and endoscopic images.

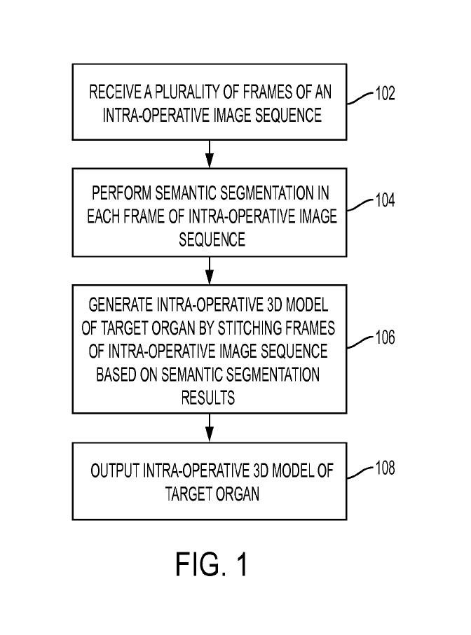

FIG. 1 illustrates a method for generating an intra-operative 3D model of a target anatomical object from 2D/2.5D intra-operative images, according to an embodiment of the present invention. The method of FIG. 1 transforms intra-operative image data representing a patient's anatomy to perform semantic segmentation of each frame of the intra-operative image data and generate a 3D model of a target anatomical object. The method of FIG. 1 can be applied to generate an intra-operative 3D model of a target organ to guide a surgical procedure being performed in the target organ. In an exemplary embodiment, the method of FIG. 1 can be used to generate an intra-operative 3D model of the patient's liver for guidance of a surgical procedure on the liver, such as a liver resection to remove a tumor or lesion from the liver.

Referring to FIG. 1, at step 102, a plurality of frames of an intra-operative image sequence are received. For example, the intra-operative image sequence can be a laparoscopic image sequence acquired via a laparoscope or an endoscopic image sequence acquired via an endoscope. According to an advantageous embodiment, each frame of the intra-operative image sequence is a 2D/2.5D image. That is each frame of the intra-operative image sequence includes a 2D image channel that provides typical 2D image appearance information for each of a plurality of pixels and a 2.5D depth channel that provides depth information corresponding to each of the plurality of pixels in the 2D image channel. For example, each frame of the intra-operative image sequence can include RGB-D (Red, Green, Blue+Depth) image data, which includes an RGB image, in which each pixel has an RGB value, and a depth image (depth map), in which the value of each pixel corresponds to a depth or distance of the pixel from the camera of the image acquisition device (e.g., laparoscope or endoscope). The image acquisition device (e.g., laparoscope or endoscope) used to acquire the intra-operative images can be equipped with a camera or video camera to acquire the RGB image for each time frame, as well as a depth sensor to acquire the depth information for each time frame. The frames of the intra-operative image sequence may be received directly from the image acquisition device. For example, in an advantageous embodiment, the frames of the intra-operative image sequence can be received in real-time as they are acquired by the image acquisition device. Alternatively, the frames of the intra-operative image sequence can be received by loading previously acquired intra-operative images stored on a memory or storage of a computer system.

According to an embodiment of the present invention, the plurality of frames of the intra-operative image sequence can be acquired by a user (e.g., doctor, technician, etc.) performing a complete scan of the target organ using the image acquisition device (e.g., laparoscope or endoscope). In this case the user moves the image acquisition device while the image acquisition device continually acquires images (frames), so that the frames of the intra-operative cover the complete surface of the target organ. This may be performed at a beginning of a surgical procedure to obtain a full picture of the target organ at a current deformation.

At step 104, semantic segmentation is performed on each frame of the intra-operative image sequence using a trained classifier. The semantic segmentation of a particular 2D/2.5D intra-operative image determines a probability for a semantic class for each pixel in the image domain. For example, a probability of each pixel in the image frame being a pixel of the target organ can be determined. The semantic segmentation is performed using a trained classifier based on statistical image features extracted from the 2D image appearance information and the 2.5D depth information for each pixel.

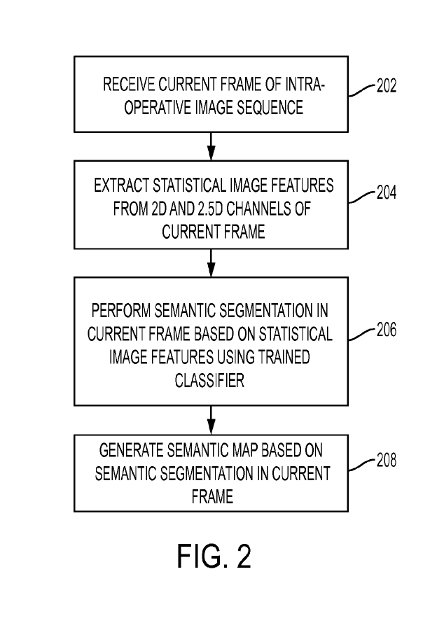

FIG. 2 illustrates a method of performing semantic segmentation of a 2D/2.5D intra-operative image according to an embodiment of the present invention. The method of FIG. 2 can be used to implement step 104 of FIG. 1. For example, in step 104 of FIG. 1, the method of FIG. 2 can be performed independently for each of the plurality of frames of the intra-operative image sequence resulting from the complete scan of the target organ. In an advantageous implementation, the method of FIG. 2 can be performed in real-time or near real-time as each frame of the intra-operative is received. However, the method of FIG. 2 is not limited such use and can be applied to perform semantic segmentation of any 2D/2.5D intra-operative image.

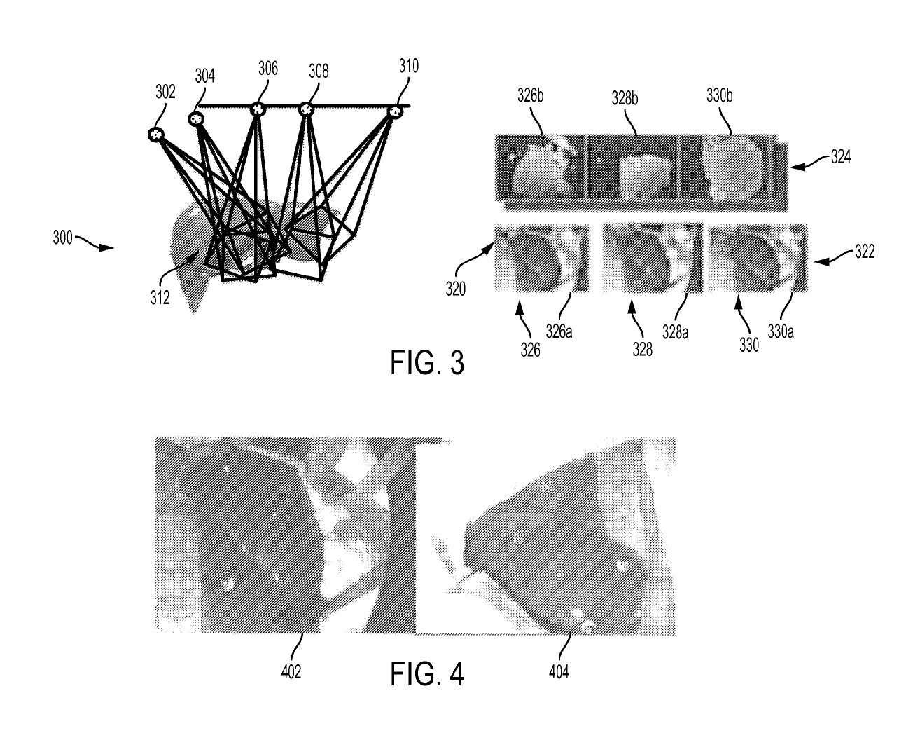

Referring to FIG. 2, at step 202, a current frame of the intra-operative image sequence is received. According to a possible implementation, the current frame of the intra-operative image sequence can be received in real-time during a surgical procedure from an image acquisition device, such as a laparoscope or endoscope. The current frame is a 2D/2.5D image that includes a 2D image channel and a 2.5D depth channel. For example, RGB-D image data for the current frame can include an RGB image, in which each pixel has an RGB value, and a corresponding depth image in which the value of each pixel corresponds to a depth or distance from the camera of the image acquisition device. The pixels in the RGB image and the depth image correspond to one another such that an RGB value and a depth value are associated with each pixel in the current frame. As described above in connection with step 102 of FIG. 2, the current frame can be one of a plurality of frames of the intra-operative image sequence obtained during a complete scanning of the target organ. FIG. 3 illustrates an exemplary scan of the liver and corresponding 2D/2.5D frames resulting from the scan of the liver. As shown in FIG. 3, image 300 shows an exemplary scan of the liver, in which a laparoscope is positioned at a plurality of positions 302, 304, 306, 308, and 310 and each position the laparoscope is oriented with respect to the liver 312 and a corresponding laparoscopic image (frame) of the liver 312 is acquired. Image 320 shows a sequence of laparoscopic images having an RGB channel 322 and a depth channel 324. Each frame 326, 328, and 330 of the laparoscopic image sequence 320 includes an RGB image 326a, 328a, and 330a, and a corresponding depth image 326b, 328b, and 330b, respectively.

Returning to FIG. 2, at step 204, statistical image features are extracted from the 2D image channel and the 2.5D depth channel of the current frame. Embodiments of the present invention utilize a combination of statistical image features learned and evaluated with a trained classifier, such as a random forest classifier. Statistical image features can be utilized for this classification since they capture the variance and covariance between integrated low-level feature layers of the image data. In advantageous implementation, the color channels of the RGB image of the current frame and the depth information from the depth image of the current frame are integrated in an image patch surrounding each pixel of the current frame in order to calculate statistics up to a second order (i.e., mean and variance/covariance). For example, statistics such as the mean and variance in the image patch can be calculated for each individual feature channel, and the covariance between each pair of feature channels in the image patch can be calculated by considering pairs of channels. In particular, the covariance between involved channels provides a discriminative power, for example in liver segmentation, where a correlation between texture and color helps to discriminate visible liver segments from surrounding stomach regions. The statistical features calculated from the depth information provide additional information related to surface characteristics in the current image. In addition to the color channels of the RGB image and the depth data from the depth image, the RGB image and/or the depth image can be processed by various filters and the filter responses can also be integrated and used to calculated additional statistical features (e.g., mean, variance, covariance) for each pixel. For example, filters such as derivation filters, filter banks. For example, any kind of filtering (e.g., derivation filters, filter banks, etc.) can be used in addition to operating on pure RGB values. The statistical features can be efficiently calculated using integral structures and parallelized, for example using a massively parallel architecture such as a graphics processing unit (GPU) or general purpose GPU (GPGPU), which enables interactive responses times for semantic segmentation such that the method of FIG. 2 can be used to provide real-time or near real-time semantic segmentation of intra-operative images acquired during a surgical procedure. The statistical features for an image patch centered at a certain pixel are composed into a feature vector. The vectorized feature descriptors for each pixel describe the image patch that is centered at that pixel.

FIG. 4 illustrates exemplary laparoscopic images of the liver. As shown in FIG. 4, images 402 and 404 are exemplary laparoscopic images showing the visual appearance of the liver. Covariance features can be used to integrate various low-level feature channels, such as RGB, filter responses, and depth information for discriminative power. Such features can be extracted from an image patch surrounding each pixel and organized into a respective feature vector for each pixel.

Returning to FIG. 2, at step 206, semantic segmentation of the current frame is performed based on the extracted statistical image features using a trained classifier. The trained classifier is trained in an offline training phase based on annotated training data. Due to the pixel level classification, the annotation or labeling of the training data can be accomplished quickly by organ annotation using strokes input by a user using an input device, such as a mouse or touch screen. The training data used to train the classifier should include training images from different acquisitions and with different scene characteristics, such as different viewpoints, illumination, etc. The statistical image features described above are extracted from various image patches in the training images and the feature vectors for the image patches are used to train the classifier. During training, the feature vectors are assigned a semantic label (e.g., liver pixel vs. background) and are used to train a machine learning based classifier. In an advantageous embodiment, a random decision tree classifier is trained based on the training data, but the present invention is not limited thereto, and other types of classifiers can be used as well. The trained classifier is stored, for example in a memory or storage of a computer system, and used in online testing to perform semantic segmentation for a given image.

In order to perform semantic segmentation of the current frame of the intra-operative image sequence, a feature vector is extracted for an image patch surrounding each pixel of the current frame, as described above in step 204. The trained classifier evaluates the feature vector associated with each pixel and calculates a probability for each semantic object class for each pixel. A label (e.g., liver or background) can also be assigned to each pixel based on the calculated probability. In one embodiment, the trained classifier may be a binary classifier with only two object classes of target organ or background. For example, the trained classifier may calculate a probability of being a liver pixel for each pixel and based on the calculated probabilities, classify each pixel as either liver or background. In an alternative embodiment, the trained classifier may be a multi-class classifier that calculates a probability for each pixel for multiple classes corresponding to multiple different anatomical structures, as well as background. For example, a random forest classifier can be trained to segment the pixels into stomach, liver, and background.

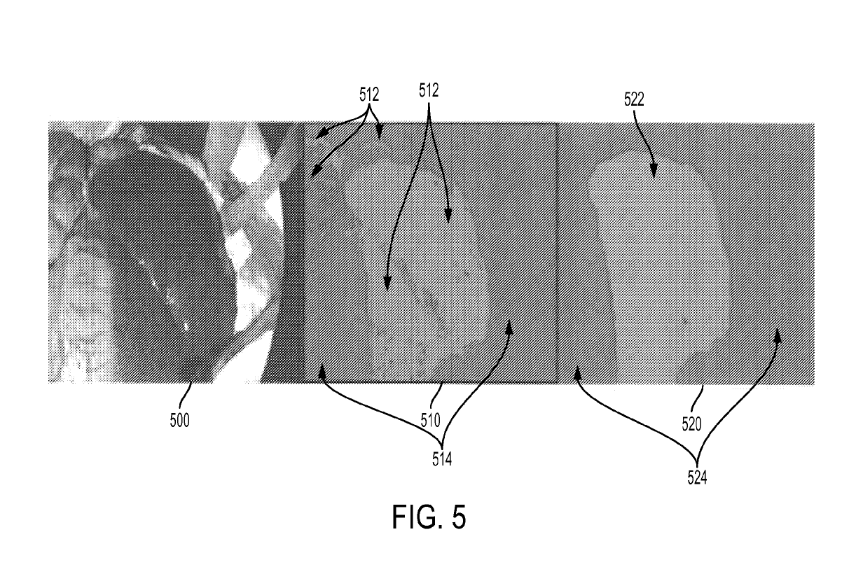

FIG. 5 illustrates exemplary results of semantic segmentation of a laparoscopic image of the liver. As shown in FIG. 5, image 500 is a laparoscopic image of the liver, and image 510 shows a pixel-level response of the trained classifier for binary segmentation of the laparoscopic image 500 into liver and background. As shown in image 510, each pixel in the image is classified as liver 512 or background 514.

Returning to FIG. 2, at step 208, a semantic map is generated based on the semantic segmentation of the current frame. Once a probability for each semantic class is calculated using the trained classifier and each pixel is labeled with a semantic class, a graph-based method can be used to refine the pixel labeling with respect to RGB image structures such as organ boundaries, while taking into account the confidences (probabilities) for each pixel for each semantic class. The graph-based method can be based on a conditional random field formulation (CRF) that uses the probabilities calculated for the pixels in the current frame and an organ boundary extracted in the current frame using another segmentation technique to refine the pixel labeling in the current frame. A graph representing the semantic segmentation of the current frame is generated. The graph includes a plurality of nodes and a plurality of edges connecting the nodes. The nodes of the graph represent the pixels in the current frame and the corresponding confidences for each semantic class. The weights of the edges are derived from a boundary extraction procedure performed on the 2.5D depth data and the 2D RGB data. The graph-based method groups the nodes into groups representing the semantic labels and finds the best grouping of the nodes to minimize an energy function that is based on the semantic class probability for each node and the edge weights connecting the nodes, which act as a penalty function for edges connecting nodes that cross the extracted organ boundary. This results in a refined semantic map for the current frame. Referring to FIG. 5, while image 510 of FIG. 5 shows the raw pixel-level response of the trained classifier for a binary liver segmentation problem, image 520 shows a semantic map generated using graph-based refinement of the pixel-level semantic segmentation 510 with respect to dominant organ boundaries. As shown in image 520, the semantic map 520 refines the pixels labeled as liver 522 and background 524 with respect to the pixel-level semantic segmentation 510.

In addition to being used in a 3D stitching procedure, the semantic segmentation results including the semantic maps resulting from step 208 and/or the pixel-level semantic segmentations resulting from step 206 can be output, for example, by displaying the semantic segmentation results on a display device of a computer system. As described above, the method of FIG. 2 can be repeated for a plurality of frames of an intra-operative image sequence. In a possible implementation, in cases in which the frame to frame motion is relatively small, additional prior information regarding the image content can be used to refine and improve the semantic segmentation, for example using an online learning and adaption technique.

Returning to FIG. 1, at step 106, an intra-operative 3D model of the target organ is generated by stitching the frames of the intra-operative image sequence based on the semantic segmentation results. Once a plurality of frames of an intra-operative image sequence corresponding to a complete scanning of the target organ are acquired and semantic segmentation is performed on each of the frames, the semantic segmentation results can be used to guide a 3D stitching of the frames to generate an intra-operative 3D model of the target organ. The 3D stitching can be performed by align individual frames with each other based on correspondences in different frames. In an advantageous implementation, connected regions of pixels of the target organ (e.g., connected regions of liver pixels) in the semantically segmented frames can be used to estimate the correspondences between the frames.

Accordingly, the intra-operative 3D model of the target organ can be generated by stitching multiple frames together based on the semantically-segmented connected regions of the target organ in the frames. The stitched intra-operative 3D model can be semantically enriched with the probabilities of each considered object class, which are mapped to the 3D model from the semantic segmentation results of the stitched frames used to generate the 3D model. In an exemplary implementation, the probability map can be used to “colorize” the 3D model by assigning a class label to each 3D point. This can be done by quick look ups using 3D to 2D projections known from the stitching process. A color can then be assigned to each 3D point based on the class label.

At step 108, the intra-operative 3D model of the target organ is output. For example, the intra-operative 3D model of the target organ can be output by displaying the intra-operative 3D model of the target organ on a display device of a computer system.

Once the intra-operative 3D model of the target organ is generated, for example at a beginning of a surgical procedure, a pre-operative 3D model of the target organ can be registered to the intra-operative 3D model of the target organ. The pre-operative 3D model can be generated from an imaging modality, such as computed tomography (CT) or magnetic resonance imaging (MRI), that provides additional detail as compared with the intra-operative images. The pre-operative 3D model of the target organ and the intra-operative 3D model of the target organ can be registered by calculating a rigid registration followed by a non-linear deformation. For example, this registration procedure registers the 3D pre-operative model of the target organ (e.g., liver) prior to gas insufflation of the abdomen is the surgical procedure with the intra-operative 3D model of the target organ after the target organ was deformed due to the gas insufflation of the abdomen in the surgical procedure. In a possible implementation semantic class probabilities that have been mapped to the intra-operative 3D model can be used in this registration procedure. Once the pre-operative 3D model of the target organ is registered to the intra-operative 3D model of the target organ, the deformed pre-operative 3D model can be overlaid on newly acquired intra-operative images (i.e., newly acquired frames of the intra-operative image sequence) in order to provide guidance to a user performing the surgical procedure. In an advantageous embodiment of the present invention, the method of FIG. 2 can be used to perform semantic segmentation on each newly acquired intra-operative image during the surgical procedure, and the semantic segmentation results for each intra-operative image can be used to align the deformed pre-operative 3D model to the current intra-operative image in order to guide the overlay of the pre-operative 3D model on the current intra-operative image. The overlaid images can then be displayed to the user to guide the surgical procedure.

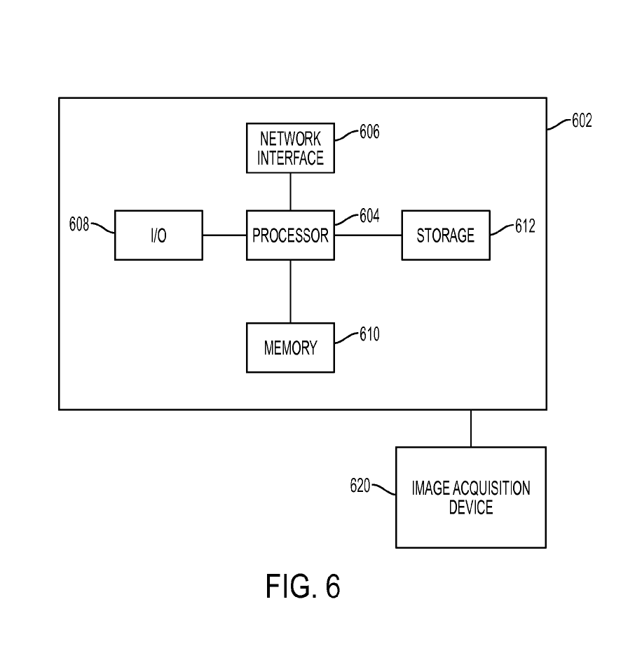

The above-described methods for semantic segmentation and generating a 3D model of an anatomical object may be implemented on a computer using well-known computer processors, memory units, storage devices, computer software, and other components. A high-level block diagram of such a computer is illustrated in FIG. 6. Computer 602 contains a processor 604, which controls the overall operation of the computer 602 by executing computer program instructions which define such operation. The computer program instructions may be stored in a storage device 612 (e.g., magnetic disk) and loaded into memory 610 when execution of the computer program instructions is desired. Thus, the steps of the methods of FIGS. 1 and 2 may be defined by the computer program instructions stored in the memory 610 and/or storage 612 and controlled by the processor 604 executing the computer program instructions. An image acquisition device 620, such as a laparoscope, endoscope, etc., can be connected to the computer 602 to input image data to the computer 602. It is possible that the image acquisition device 620 and the computer 602 communicate wirelessly through a network. The computer 602 also includes one or more network interfaces 606 for communicating with other devices via a network. The computer 602 also includes other input/output devices 608 that enable user interaction with the computer 602 (e.g., display, keyboard, mouse, speakers, buttons, etc.). Such input/output devices 608 may be used in conjunction with a set of computer programs as an annotation tool to annotate volumes received from the image acquisition device 620. One skilled in the art will recognize that an implementation of an actual computer could contain other components as well, and that FIG. 6 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. (canceled)

2. (canceled)

3. (canceled)

4. The method of claim 18, wherein extracting the statistical features that integrate information from the 2D image channel and information from the 2.5D depth channel in an image patch surrounding the pixel comprises:
extracting a covariance between the 2D image channel and the 2.5D depth channel in the image patch surrounding the pixel.

5. The method of claim 18, wherein each frame of the intra-operative image sequence is an RGB-D image including an RGB image and a corresponding depth image, and extracting the statistical features that integrate information from the 2D image channel and information from the 2.5D depth channel in an image patch surrounding the pixel comprises:
calculating statistical features that integrate a set of feature channels including color channels of the RGB image and depth data of the depth image in the image patch surrounding the pixel.

6. The method of claim 5, wherein calculating statistical features that integrate a set of feature channels including color channels of the RGB image and depth data of the depth image in the image patch surrounding the pixel comprises:
calculating a respective mean for each of feature channels in the image patch; and
calculating a covariance between each pair of the feature channels in the image patch.

7. The method of claim 6, wherein the set of feature channels further includes filter responses of at least one of the RGB image or the depth image using one or more filters.

8. (canceled)

9. (canceled)

10. (canceled)

11. (canceled)

12. (canceled)

13. The method of claim 15, wherein the the step of performing semantic segmentation on each frame of the intra-operative image sequence to classify each of a plurality of pixels in each frame with respect to a semantic object class of the target organ is performed in real-time in response to acquiring each frame of the intra-operative image sequence in a surgical procedure.

14. (canceled)

15. A method of generating a 3D model of a target organ from an intra-operative image sequence, comprising:
receiving a plurality of frames of an intra-operative image sequence, wherein each frame is a 2D/2.5D image including a 2D image channel and a 2D depth channel and the plurality of frames are acquired at a plurality of orientations with respect to the target organ;
performing semantic segmentation on each frame of the intra-operative image sequence to classify each of a plurality of pixels in each frame with respect to a semantic object class of the target organ; and
generating a 3D model of the target anatomical object by stitching individual frames of the plurality of frames acquired at the plurality of orientations with respect to the target organ together using correspondences between pixels classified in the semantic object class of the target organ in the individual frames.

16. The method of claim 15, wherein the intra-operative image sequence is one of a laparoscopic image sequence or an endoscopic image sequence and the plurality of frames corresponds to a scan of the target organ using one of a laparoscope or an endoscope.

17. The method of claim 15, wherein performing semantic segmentation on each frame of the intra-operative image sequence to classify each of a plurality of pixels in each frame with respect to a semantic object class of the target organ comprises:
for each of the plurality of frames in the intra-operative image sequence:
extracting statistical features from the 2D image channel and the 2.5D depth channel for each of the plurality of pixels in the frame; and
classifying each of the plurality of pixels in the frame with respect to the semantic object class of a target organ based on the statistical features extracted for each of the plurality of pixels using a trained classifier.

18. The method of claim 17, wherein extracting statistical features from the 2D image channel and the 2.5D depth channel for each of the plurality of pixels in the frame comprises:
for each of the plurality of pixels in the frame, extracting the statistical features that integrate information from the 2D image channel and information from the 2.5D depth channel in an image patch surrounding the pixel.

19. The method of claim 17, wherein classifying each of the plurality of pixels in the frame with respect to the semantic object class of a target organ based on the statistical features extracted for each of the plurality of pixels using a trained classifier comprises:
calculating a probability for the semantic object class of the target organ for each of the plurality of pixels in the frame based on the statistical features extracted for each of the plurality of pixels using the trained classifier.

20. The method of claim 17, wherein the trained classifier is a trained random forest classifier.

21. The method of claim 17, wherein performing semantic segmentation on each frame of the intra-operative image sequence to classify each of a plurality of pixels in each frame with respect to a semantic object class of the target organ further comprises:
refining the classification of the plurality of pixels in each frame of the intra-operative image sequence using a graph-based method based on probabilities for the semantic object class of the target organ calculated for the plurality of pixels in that frame by the trained classifier and a dominant organ boundary for the target organ extracted from the intra-operative image.

22. The method of claim 15, further comprising:
registering a pre-operative 3D model of the target organ with the generated 3D model of the target organ;
receiving a new frame of the intra-operative image sequence; and
overlaying the registered pre-operative 3D model of the target organ on the new frame of the intra-operative image sequence.

23. The method of claim 22, wherein overlaying the registered pre-operative 3D model of the target organ on the new frame of the intra-operative image sequence comprises:
performing semantic segmentation on the new frame of the intra-operative image sequence to classify each of a plurality of pixels in the new frame with respect to the semantic object class of the target organ; and
aligning the registered pre-operative 3D model of the target organ to the new frame of the intra-operative image sequence based on the pixels classified in the semantic object class of the target organ in the new frame of the intra-operative image sequence.

24. The method of claim 15, wherein the target organ is the liver.

25. (canceled)

26. (canceled)

27. (canceled)

28. (canceled)

29. An apparatus for generating a 3D model of a target organ from an intra-operative image sequence, comprising:
means for receiving a plurality of frames of an intra-operative image sequence, wherein each frame is a 2D/2.5D image including a 2D image channel and a 2D depth channel and the plurality of frames are acquired at a plurality of orientations with respect to the target organ;
means for performing semantic segmentation on each frame of the intra-operative image sequence to classify each of a plurality of pixels in each frame with respect to a semantic object class of the target organ; and
means for generating a 3D model of the target anatomical object by stitching individual frames of the plurality of frames acquired at the plurality of orientations with respect to the target organ together using correspondences between pixels classified in the semantic object class of the target organ in the individual frames.

30. The apparatus of claim 29, wherein means for performing semantic segmentation on each frame of the intra-operative image sequence to classify each of a plurality of pixels in each frame with respect to a semantic object class of the target organ comprises:
means for extracting statistical features from the 2D image channel and the 2.5D depth channel for each of the plurality of pixels in each frame; and
means for classifying each of the plurality of pixels in each frame with respect to the semantic object class of a target organ based on the statistical features extracted for each of the plurality of pixels using a trained classifier.

31. The apparatus of claim 30, wherein the means for extracting statistical features from the 2D image channel and the 2.5D depth channel for each of the plurality of pixels in the frame comprises:
means for extracting the statistical features that integrate information from the 2D image channel and information from the 2.5D depth channel in a respective image patch surrounding each of the plurality of pixels in each frame.

32. (canceled)

33. (canceled)

34. (canceled)

35. (canceled)

36. (canceled)

37. A non-transitory computer readable medium storing computer program instructions for generating a 3D model of a target organ from an intra-operative image sequence, the computer program instructions when executed by a processor cause the processor to perform operations comprising:
receiving a plurality of frames of an intra-operative image sequence, wherein each frame is a 2D/2.5D image including a 2D image channel and a 2D depth channel and the plurality of frames are acquired at a plurality of orientations with respect to the target organ;
performing semantic segmentation on each frame of the intra-operative image sequence to classify each of a plurality of pixels in each frame with respect to a semantic object class of the target organ; and
generating a 3D model of the target anatomical object by stitching individual frames of the plurality of frames acquired at the plurality of orientations with respect to the target organ together using correspondences between pixels classified in the semantic object class of the target organ in the individual frames.

38. The non-transitory computer readable medium of claim 37, wherein
performing semantic segmentation on each frame of the intra-operative image sequence to classify each of a plurality of pixels in each frame with respect to a semantic object class of the target organ comprises:
for each of the plurality of frames in the intra-operative image sequence:
extracting statistical features from the 2D image channel and the 2.5D depth channel for each of the plurality of pixels in the frame; and
classifying each of the plurality of pixels in the frame with respect to the semantic object class of a target organ based on the statistical features extracted for each of the plurality of pixels using a trained classifier.

39. The non-transitory computer readable medium of claim 38, wherein extracting statistical features from the 2D image channel and the 2.5D depth channel for each of the plurality of pixels in the frame comprises:
for each of the plurality of pixels in the frame, extracting the statistical features that integrate information from the 2D image channel and information from the 2.5D depth channel in an image patch surrounding the pixel.

40. The non-transitory computer readable medium of claim 38, wherein classifying each of the plurality of pixels in the frame with respect to the semantic object class of a target organ based on the statistical features extracted for each of the plurality of pixels using a trained classifier comprises:
calculating a probability for the semantic object class of the target organ for each of the plurality of pixels in the frame based on the statistical features extracted for each of the plurality of pixels using the trained classifier.

41. The non-transitory computer readable medium of claim 37, wherein the operations further comprise:
registering a pre-operative 3D model of the target organ with the generated 3D model of the target organ;
receiving a new frame of the intra-operative image sequence; and
overlaying the registered pre-operative 3D model of the target organ on the new frame of the intra-operative image sequence.

42. The non-transitory computer readable medium of claim 41, wherein overlaying the registered pre-operative 3D model of the target organ on the new frame of the intra-operative image sequence comprises:
performing semantic segmentation on the new frame of the intra-operative image sequence to classify each of a plurality of pixels in the new frame with respect to the semantic object class of the target organ; and
aligning the registered pre-operative 3D model of the target organ to the new frame of the intra-operative image sequence based on the pixels classified in the semantic object class of the target organ in the new frame of the intra-operative image sequence.
